(19) United States
(12) Patent Application Publication
(10) Pub. No.: US 2026/0024838 A1
(43) Pub. Date: Jan. 22, 2026

(54) LINE SYSTEM WITH A PLURALITY OF OUTLETS

(71) Applicant: TI Automotive Technology Center GmbH, Rastatt (DE)

(72) Inventors: Irfan KIZILAY, Reilingen (DE); Stefan LEIPOLD, Seltz (FR); Manuel ROEDER, Rastatt (DE); Jens TRAUTVETTER, Beinheim (FR)

(21) Appl. No.: 19/273,665

(22) Filed: Jul. 18, 2025

(30) Foreign Application Priority Data
Jul. 18, 2024 (DE) 102024120452.4

(51) Int. Cl. H01M 10/6552; H01M 10/625

(52) U.S. Cl. CPC H01M 10/6552; H01M 10/625

(57) ABSTRACT

A main line for distributing or collecting a medium, in particular a temperature control medium, has a main tube and at least three outlets. The outlets are connected to the main tube, wherein the outlets are each assigned to an opening of the main tube and are connected to the respectively assigned opening. The main tube comprises an axis A and defines an axial direction. The main tube and/or at least one of the outlets comprises an elastomer.

### RELATED APPLICATIONS

The present disclosure claims priority to and the benefit of German Application 102024120452.4, filed on Jul. 18, 2024, the entire contents of each of which are incorporated herein by reference.

### FIELD

The present disclosure relates to a main line for distributing or collecting a medium, in particular a temperature control medium, for example for a drive battery of a vehicle. The present disclosure further relates to a line system comprising such a main line, a use of such a main line or such a line system, and a method for manufacturing such a main line.

### BACKGROUND

A main line is disclosed in CN 117317437 A. A main outlet of a main line allows the medium in the form of a temperature control medium to flow into or out of a main tube. The main tube is located inside a housing of a drive battery and has several secondary outlets, all of which are arranged inside the housing. The secondary outlets are connected to plate-shaped, hollow heat exchangers standing on edge, which extend along a longitudinal extension of the drive battery inside the housing and cool or heat the battery cells as required.

After passing through the heat exchangers, the temperature control medium reaches second secondary outlets of a second main line in accordance with CN 117317437 A. The second main line also comprises a second main tube and a second main outlet. The temperature control medium flows from the second secondary outlets into the second main tube, from there into the second main outlet and finally out of the housing of the drive battery. The flow direction of the temperature control medium is reversed as soon as a change from cooling mode to heating mode or vice versa takes place. The two main lines together form a line system, which in turn is a component of a fluid system. The fluid system may in particular also have a tank for the temperature control medium and/or a pump and/or a heat sink and/or a heat source.

The heat exchangers, which are preferably made of aluminum, are often manufactured by different suppliers than the tube systems, which are usually made predominantly of plastic. Due to the limited space inside the housing, the sometimes large number of secondary outlets (in some cases more than ten per main tube) and the interaction of several components or suppliers (battery housing, heat exchangers, tube systems), high precision of the tube system and tolerance requirements for the connection of the secondary outlets to the heat exchangers is necessary.

For this reason, it is common practice to fit the outlets or secondary outlets with short corrugated tube segments, which gives the secondary outlets greater flexibility and allows the tolerance requirements for connecting the secondary outlets to the heat exchangers to be met without any problems. For this purpose, the corrugated tube segments of the secondary outlets are connected to a connecting part on the main tube side and a line connector on the heat exchanger side. The connecting part is used to provide a preferably material-locking connection between the main tube and the corrugated tube segment of the secondary outlet. The line connector is used to connect the corrugated tube segment of the secondary outlet to the heat exchanger.

Three welding operations (connecting part to corrugated tube segment and line connector to corrugated tube segment) are required to manufacture each secondary outlet in accordance with the procedure known from practice. A third welding operation is then used to connect the secondary outlet or the connecting part to the main tube. In addition, three parts of the secondary outlet are manufactured separately. This procedure, which is known from practice, is therefore associated with high manufacturing costs.

### BRIEF SUMMARY

The present disclosure reduces the manufacturing costs for the main line or the line system.

A main line for distributing or collecting a medium, in particular a temperature control medium, having a main tube and at least three outlets, wherein the outlets are connected to the main tube, wherein the outlets are each assigned to an opening of the main tube and are connected to the respectively assigned opening, wherein the main tube comprises an axis and defines an axial direction, and wherein the main tube and/or at least one of the outlets comprises an elastomer.

We have discovered that an elastomer allows greater flexibility of the main tube or the outlets. This makes it much easier to install the main line in the narrow housing. As a result, the corrugated tube segments of the outlets or secondary outlets can be dispensed with, so that the secondary outlet can be formed by a single injection-molded part. This part, in particular a line connector, can be connected to the main tube by welding, for example, and may also have a coupling section for a detachable connection to the heat exchanger. Thus, due to the elastomer in the main tube, only one welding operation and only one injection molding per outlet is required. As a result, the manufacturing effort has been reduced and the drawbacks mentioned at the beginning are overcome.

According to one embodiment, the corrugated tube segments of the outlets of the prior art known from practice can preferably be replaced by corrugated tube-free outlets comprising the elastomer or additionally provided with the elastomer, whereby particularly flexible outlets are achieved. This significantly improves the handling of the outlets, in particular during installation or maintenance/repair.

The term “axial” preferably refers to one or the axis or center axis of the main tube. It is possible that the main tube is bent so that the axial direction depends on the axial position of the main tube. A plurality of radial directions and/or circumferential directions or tangential directions conveniently belong to a specific axial direction. In the case of a bent main tube, not only are the axial directions position-dependent, but also the radial directions and the circumferential directions. For practical purposes, the directional terms “axial,” “radial,” and “tangential” each refer to a specific position or section of the main tube. The directional specifications can be applied analogously to the secondary outlets and/or the main outlet.

The openings of the main tube for connecting the outlets can be arranged on the end faces and/or in a circumferential lateral surface of the main tube. The lateral surface of the main tube may have one or more corrugated tube segments and preferably at least one section without corrugation. It is preferred that the circumferential lateral surface comprises at least some and preferably all of the openings associated with the outlets.

According to a highly preferred embodiment, one of the outlets is a main outlet, wherein at least one of the outlets is a secondary outlet, wherein preferably an inner diameter of the main outlet and/or of the main tube is at least axially section wise larger than an inner diameter of the at least one secondary outlet or of a section of the at least one secondary outlet. The inner diameter of the at least one secondary outlet may be smaller than an inner diameter of the main outlet at only one point and may in particular be designed as a reducer. This serves to optimize the pressure of the temperature control medium as much as possible.

The main line preferably comprises at least 4/5/6/7/8/9/10/11 outlets. It is possible that at least 2/3/4/5/6/7/8/9/10 of the outlets are secondary outlets. It is possible that the main line comprises only one main outlet. Conveniently, at least one or only one of the openings is a main opening. Advantageously, at least one /2/3/4/5/6/7/8/9/10 of the openings is a secondary opening. Preferably, the at least one secondary opening or the secondary openings of the main tube are assigned to the at least one secondary outlet or to the secondary outlets. The main opening of the main tube is preferably assigned to the main outlet. Advantageously, a clear area of the secondary opening or of one of the secondary openings is smaller than a clear area of the main opening.

Conveniently, the main tube comprises at least one outlet section and/or at least one intermediate section. Preferably, the outlet section comprises one and, in particular, only one outlet or secondary outlet or main outlet. It is preferred that an axial extension of the outlet section is identical to an axial extension of the outlet/main outlet/secondary outlet or to the largest axial extension of one of the outlets of the outlet section. Advantageously, the number of outlet sections corresponds to the number of outlets or secondary outlets.

It is expedient for the at least one intermediate section to be arranged in the axial direction between two outlet sections, preferably immediately adjacent to each other. The at least one intermediate section is preferably designed without outlets. Advantageously, the number of intermediate sections corresponds to the number of outlets or secondary outlets minus 1. It is possible for the intermediate section to be designed at least partially and preferably completely without corrugated tubes.

According to a preferred embodiment, the main tube is designed in one piece, preferably at least integrally in layers and particularly preferably completely integrally. This achieves long-lasting fluid tightness. In addition, this achieves relatively low manufacturing costs in relation to the manufacture of the main line or the main tube. The main tube or the tube wall of the main tube may have only one layer at least axially in sections and preferably along the entire length. The main tube or the tube wall may have several layers. The main tube advantageously has a length of at least 20 or 30 or 50 or 70 or 90 cm. It is preferred that the main tube comprises a plastic and preferably comprises at least 50 or 70 or 90% by weight of plastic. The plastic is preferably a thermoplastic and may comprise, for example, a polyamide and/or a thermoplastic elastomer.

The main line may comprise at least one end closure or two end closures. This allows any length of the main tube to be provided, which can be manufactured from a thread-extruded tube. The end closure or end closures are preferably inserted into the main tube, in particular at one or both axial ends. Advantageously, the end closure or end closures seal the main tube in the axial direction. The end closure or end closures are preferably connected to the main tube in a material-locking manner.

The term “one-piece” or “monolithic” preferably means that the one-piece body can only be divided into two or more pieces in a destructive manner, for example by cutting. An example of a one-piece design is a tube with several coextruded layers, which is one-piece but not integral across the entire tube wall. The term “integral” preferably means a body which is formed from only one melt. For example, injection-molded bodies with only one plastic melt are integrally formed bodies. Consequently, a multilayer, coextruded tube is integrally formed layer by layer and is also one-piece overall or across the entire tube wall, but not integrally formed across the entire tube wall. The reason for this is that each of the tube layers is assigned to its own melt. The different tube layers are conveniently recognizable microscopically or by other imaging techniques, particularly at the interfaces between the layers.

It is preferred that the weight proportion of the elastomer is at least 30 or 40 or 50 or 60 or 70 or 80%. This ensures good flexibility of the main tube. The elastomer is preferably a thermoplastic elastomer and particularly preferably a thermoplastic vulcanizate. The elastomer advantageously comprises/is an EPDM. The elastomer preferably comprises polypropylene. The elastomer particularly advantageously comprises an EPDM and a polypropylene or an EPDM in a polypropylene matrix.

It is preferable that the main tube has at least one cross burr and preferably a plurality of cross burrs on its outer side. This is a feature of manufacturing the main tube using chain links, which allows for cost-effective production of the main tube. In particular, molding tools with chains or chain links are relatively inexpensive. Cross burrs can also be a feature of a 3D blow molding process, which allows for a high number of variants in the production of the main tube. In the case of a 3D blow molding process, components such as end caps can be integrated into the main line. It is possible that at least one cross burr, and preferably two cross burrs, are arranged between two outlets or secondary outlets, in particular in each case. It is possible that a cross burr is arranged in a middle, axial third of an intermediate section. It is preferred that a cross burr is arranged in an axially outer third of an intermediate section. It is preferred that a first cross burr is arranged in a first axially outer third of an intermediate section and a second cross burr is arranged in a second axially outer third of an intermediate section.

Advantageously, the main tube comprises at least one longitudinal burr and, in particular, two longitudinal burrs, which extend on an outer side of the main tube in an axial direction or parallel to the axis. Preferably, the two longitudinal burrs are diametrically opposite each other. Longitudinal burrs are conveniently formed by shaping the outlet sections when chain links of two chains abut each other. Consequently, longitudinal burrs are a characteristic feature of the manufacture of the outlet sections by means of chain links, thereby achieving a cost-effective manufacture.

According to a particularly preferred embodiment, at least one of the openings or secondary openings or the main opening is formed by a connection port, wherein the connection port protrudes from an outer surface of the main tube in a cross-section of the main tube, preferably at least in sections, in particular radially outward. This provides a simple means of connecting the outlets to the main tube. This allows, in particular, a relatively large number of simple standard components of the secondary outlets to be easily connected to the main tube. The term “protrudes” means, in particular, that a bulge of the wall of the main tube is visible in the cross-section of the main tube. Conveniently, the connection port protrudes radially outward or inward relative to an outer surface of the circumferential lateral surface of the main tube. The connection port is preferably ring-shaped and, in particular, circular ring-shaped. It is possible for the connection port to protrude radially inward relative to a tube wall or an outer surface of the main tube. It is possible for the connection port to protrude neither radially inward nor radially outward, so that the connection port is conveniently limited to the associated opening in the main tube. It is advantageous for the connection port to be designed so that a circular connection section of the outlet or secondary outlet or main outlet can be attached to the connection port. It is advantageous that the lowest point of the connection port protrudes at least 1/1, 5/2/2, 5/3/3, 5/4 mm radially outward relative to an outer surface or the surrounding lateral surface of the main tube. It is advantageous for a highest point of the connection port to protrude radially outwards by no more than 20 or 15 or 10 or 8 or 6 mm from an outer surface of the circumferential lateral surface of the main tube.

Advantageously, at least one of the outlets or secondary outlets comprises a connector or line connector, wherein the line connector preferably comprises a connection section and the connection section is connected to the main tube or to an associated secondary opening or to an associated connection port of the main tube, in particular in a material-locking manner and particularly preferably by welding. The direct connection of a line connector to the main tube eliminates the need for welding, so that only one welding operation is required for each secondary outlet. In particular, this eliminates the need for tube sections of the secondary outlets, which in turn must be connected to the respective line connector on one side and to a connecting part on the other side so that the connecting part can finally be connected to the main tube in a final welding operation.

The line connector preferably comprises a line connector body and a seal or, in particular, a sealing ring. The line connector body is particularly preferably designed in one piece and, in particular, integrally. Advantageously, the line connector body comprises a connection section and/or a coupling section and/or a middle section. It is preferred that the connection section of the line connector body is connected to the main tube or an opening or secondary opening or a connection port or a tube section, in particular in a material-locking manner and, in particular, by welding.

According to one embodiment, at least one of the outlets or secondary outlets comprises a tube section and/or a connection part or connecting part and/or a line connector. This greater manufacturing effort offers the advantage that the connection flexibility is significantly increased. The connecting part or connection piece can be designed as a single piece and, in particular, as an integral part. It is advantageous for the tube section to be connected to the line connector, in particular in a material-locking manner and preferably by welding. It is possible for the tube section to be connected to the connecting part, in particular in a material-locking manner and preferably by welding. The connecting part or connection piece is advantageously connected to the main tube or to one of the openings or to a connection port of the main tube, in particular in a material-locking manner and preferably by welding.

The tube section or tube sections may comprise an elastomer, preferably a thermoplastic elastomer. The tube section or sections can be formed in one piece and preferably integrally and can be produced, for example, by injection molding. The tube section or sections can be connected at a first end to the main tube, in particular by welding, so that a connecting part is advantageously not required. The tube section or sections can be connected to the line connector at a second end, in particular by welding.

It is advantageous if at least one of the outlets comprises a coupling section for connecting to a fluid component, preferably in a detachable manner. The fluid component is preferably part of a drive battery. It is very advantageous if the line connector or line connector body or coupling section has at least one latching element and preferably two latching elements for a latching connection to a fluid component. This allows a further fluid component, e.g. a heat exchanger of a drive battery, to be connected to the main tube by providing only one line connector. This allows these fluid components to be connected quickly and conveniently to the main line. It is advantageous if at least one of the outlets or secondary outlets has a connector or line connector, wherein the secondary outlet or the connector or the line connector or line connector body comprises a coupling section for connecting, preferably detachably, to a fluid component, in particular a drive battery.

The at least one latching element is advantageously designed to be spring-elastic. Advantageously, the at least one latching element is designed as a latching arm, which preferably has a latching tab. The latching tab may be able to engage in a complementary recess in the fluid component. It is preferred that the two latching arms are diametrically opposite each other with respect to an axis of the coupling section. Preferably, a longitudinal extension of the at least one latching arm extends parallel to an axis of the coupling section. It is preferred that the at least one latching arm is resiliently movable in the radial direction.

It is preferred that the line connector has a seal or a sealing ring. Advantageously, the line connector or the line connector body or the coupling section of the line connector body comprises a circumferential sealing groove into which the seal or the sealing ring is inserted. It is preferred that the coupling section has an outer side in which the sealing groove is arranged. Advantageously, the at least one latching element is arranged radially outside the sealing groove or the seal. Conveniently, the seal and the at least one latching element define a free space between them in the radial direction, into which a complementary coupling section of a fluid component to be connected to the line connector can be inserted.

Advantageously, the at least one secondary outlet or the at least one line connector or the at least one line connector body or the at least one tube section or the at least one connecting part or the at least one connection piece of the at least one secondary outlet comprises a plastic or comprises at least 50 or 70 or 90 wt. % plastic.

It is possible that the main tube comprises at least one corrugated tube segment and preferably at least two or more corrugated tube segments. This further increases the flexibility of the main tube. The term “corrugated tube segment” preferably means a section with repeatedly alternating inner and/or outer diameters. The contour of the inner and/or outer diameter may be sinusoidal, rectangular, or sawtooth-shaped in a longitudinal section of the corrugated tube segment, for example, so that the term “corrugated” does not preferably extend only to sinusoidal contours.

Preferably, the at least one intermediate section or at least one of the or some of the or each of the intermediate sections comprises at least one and preferably only one corrugated tube segment. Advantageously, the corrugated tube segment or sections are assigned only to one of the intermediate sections or to the intermediate sections and are only part of the intermediate sections and, in particular, are not part of the outlet sections. It is possible for an intermediate section to have at least one corrugated tube-free partial section.

It is advantageous that the at least one outlet section overlaps in the axial direction with one of the openings or the associated opening. This results in smooth and, in particular, cylindrical walls or walls without alternating outer or inner diameters, which makes the openings more suitable for connection to the outlets. Preferably, at least 50%, 70%, 90%, or 95% of the axial extension of an opening, main opening, or secondary opening overlap in the axial direction with an associated outlet section. It is preferred that the outlet section is designed without corrugated tubing along at least one axial section—at least partially and preferably completely over one circumference. It is possible that a section of the main tube or the outlet section facing away from the opening or a section of the main tube opposite the opening is corrugated. Preferably, at least 50% or 70% or 90% or 95% of the axial extension of the main opening in the axial direction overlaps with an associated outlet section.

It is preferred that the at least one corrugated tube segment or intermediate section is arranged in the axial direction between two of the openings or that each of the corrugated tube segments is located between two of the openings. It is advantageous that the main tube comprises at least 2/3/4/5/6/7/8 outlet sections. It is highly preferred that the number of outlet sections corresponds to the number of outlets or the number of secondary outlets. It is possible that the number of intermediate sections corresponds to the number of outlets−1 or the number of secondary outlets−1. It is advantageous that the main outlet is assigned to an outlet section to which a secondary outlet is also assigned. Preferably, at least one of the openings is completely enclosed in the axial direction by a corrugated tube-free area.

A line system for distributing and collecting a temperature control medium comprises a first main line according to the present disclosure, and a second main line according to the present disclosure. This causes the effects of the main line to extend to the entire line system. The second main line preferably has a second main outlet and/or a second main tube and/or secondary outlets. It is possible for the second main line to have the features of the main line according to the present disclosure and preferably all the features of the main line according to the present disclosure.

A use of a main line or a line system according to the present disclosure can be for temperature control of a mobile or stationary device and, in particular, a mobile or stationary battery. The mobile battery is preferably a drive battery of a vehicle. The main line or the line system are particularly advantageous for drive batteries, since drive batteries often have a large number of heat exchangers through which the temperature control medium flows in parallel. The stationary device can be a distribution device or a battery storage device, for example a battery storage device for an uninterruptible power supply for a critical device or a battery storage device for stabilizing the voltage network. The medium is preferably a temperature control medium. The medium/temperature control medium may be liquid and/or gaseous. The medium/temperature control medium may only be in liquid form.

A method for manufacturing a main line, in particular a main line according to the present disclosure includes making the main tube from an extruded or coextruded tube.

The preferred extrusion allows for particularly favorable forming tools. Conveniently, the tube is extruded by means of an extruder. It is possible for the tube to be extruded with only one layer or coextruded with several layers. The tube may be a preform which is inserted into a blow mold. Preferably, the blow mold forms the tube into a main tube.

Preferably, a forming tool for producing at least one outlet section and/or an intermediate section on the main tube is connected downstream of the extruder. It is preferred that the tube extends in one piece from the extruder to the molding tool or the molding area of the molding tool. According to another embodiment, the tube is wound up after extrusion, then stored in a wound state and then fed to the molding tool.

Advantageously, the forming tool comprises two chains, each with a plurality of chain links. Conveniently, the two chains are moved in a circular manner. Advantageously, the directions of rotation of the two chains are opposite to each other. It is preferred that the two chains or chain links of the circulating chains strike opposite chain links of the other chain in a forming area. It is advantageous for the chain links of both chains in the forming area to have the same speed and the same direction of movement as the main tube. It is advantageous for the tube to be subjected to internal pressure during forming in the forming area of the forming tool.

It is advantageous to have a cutting tool downstream of the forming tool in the direction of travel of the main tube. The cutting tool conveniently comprises a cutting element which cuts off end pieces from connection ports of the main tube. It is advantageous to have a separating tool downstream of the cutting tool. The separating tool conveniently cuts through the tube and divides it into main tubes.

### BRIEF DESCRIPTION OF THE DRAWINGS

The present disclosure is explained below with reference to five figures and two embodiments. The following figures show schematic representations

FIG. 1 a perspective view of a main line according to the present disclosure,

FIG. 2 an enlarged section of FIG. 1,

FIG. 3 an enlarged longitudinal section through the main line from FIG. 1,

FIG. 4 shows a side view of the main line from FIG. 1, but without secondary outlets and in enlarged form, and

FIG. 5 shows a side view of a second embodiment of a main line according to the present disclosure.

### DETAILED DESCRIPTION

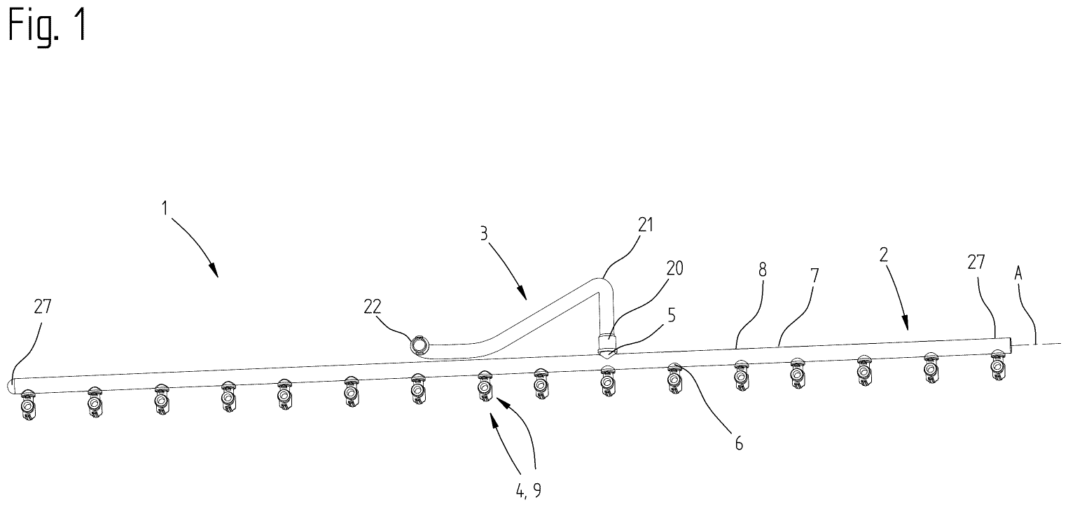

According to FIG. 1, a main line 1 according to the present disclosure comprises a main tube 2 and a plurality of outlets 3, 4. The plurality of outlets 3, 4 conveniently comprises a main outlet 3 and a plurality of secondary outlets 4. The main line 1 is preferably designed to conduct a temperature control medium through the main outlet 3 to the main tube 2, from where the temperature control medium is distributed to the plurality of secondary outlets 4. It is preferred that the plurality of secondary outlets 4 be connected to a corresponding plurality of heat exchangers within, for example, a drive battery of a vehicle.

The heat exchangers not shown here may, for example, be plate-shaped, hollow elements made of aluminum. However, the heat exchangers may also be flat, corrugated, and hollow elements. In addition, the heat exchangers may also be tubular in design, for example. It is highly preferred that the heat exchangers are located within the drive battery or a housing of the drive battery. It is also expedient for the main line 1 to be arranged within the housing of a drive battery.

It is expedient for a further main line 1 to be arranged in the direction of flow after the heat exchangers, which is preferably identical to the main line 1. The further main line may also have as many secondary outlets so that the further main line collects the temperature control medium from the plurality of heat exchangers in a main tube of the further main line and forwards it from there to a further main outlet. The two main lines 1 together preferably form a line system which ensures that the drive battery is temperature-controlled over as large an area as possible.

It is advantageous for the line system to be designed so that the temperature control medium can flow in both directions, so that a cooling mode and a heating mode are provided for cooling or heating the drive battery. In addition to lower manufacturing costs for identical main lines 1 before and after the heat exchangers, identical main lines 1 also mean that the temperature control medium experiences comparable fluidic resistance in both flow directions, which can be advantageous from a design point of view and can simplify system simulation and design.

The two main lines 1 of the line system can be arranged diametrically opposite each other with respect to the heat exchangers. According to one embodiment, the main line 1 and the other main line are located on the same side with respect to the heat exchangers or in the immediate vicinity. It is possible for the heat exchangers to be designed so that the temperature control medium first flows through a flow path within a heat exchanger and then flows back to the main lines along a return path within the same heat exchanger.

With reference to FIG. 1, the main tube 2 preferably has a plurality of outlet sections 8. The outlet sections 8 are conveniently alternated along an axis A of the main tube 2 with intermediate sections 7. It is highly preferred that the secondary outlets 4 and/or the main outlet 3 are each connected to an outlet section 8. It is expedient to provide only one secondary outlet 4 per outlet section 8. It is possible for one of the secondary outlets 4 and the main outlet 3 to be connected to the same outlet section 8.

In this embodiment, the main outlet 3 comprises a connecting body 20, a tube section 21 and/or a tube connector 22. The fluid flow can then be guided outside a drive battery housing, which is also not shown here, via a further tube connected to the main outlet 3 or to the tube connector 22 and not shown here. The tube connector 22 may be designed in particular as a quick connector or as a connector with a latching element.

It is possible for the connecting body 20 to be fastened to the tube section 21 and/or to the main tube 2 in a material-locking manner, in particular by welding. Conveniently, the main tube 2 comprises a main opening 5 to which the connecting body 20 is connected. The main opening 5 may in particular be formed by an opening projection which preferably projects radially outwardly relative to a preferably oval or cylindrical outer surface of the main tube 2.

In this embodiment, the main tube 2 has a closed tube end 27 at least one of both and advantageously at both axial ends. It is preferred that the main tube 2 has one of the secondary openings 6 at least one outlet section 8, preferably at several outlet sections 8, and most preferably at all outlet sections 8. The secondary outlets 4 are conveniently connected to the secondary openings 6.

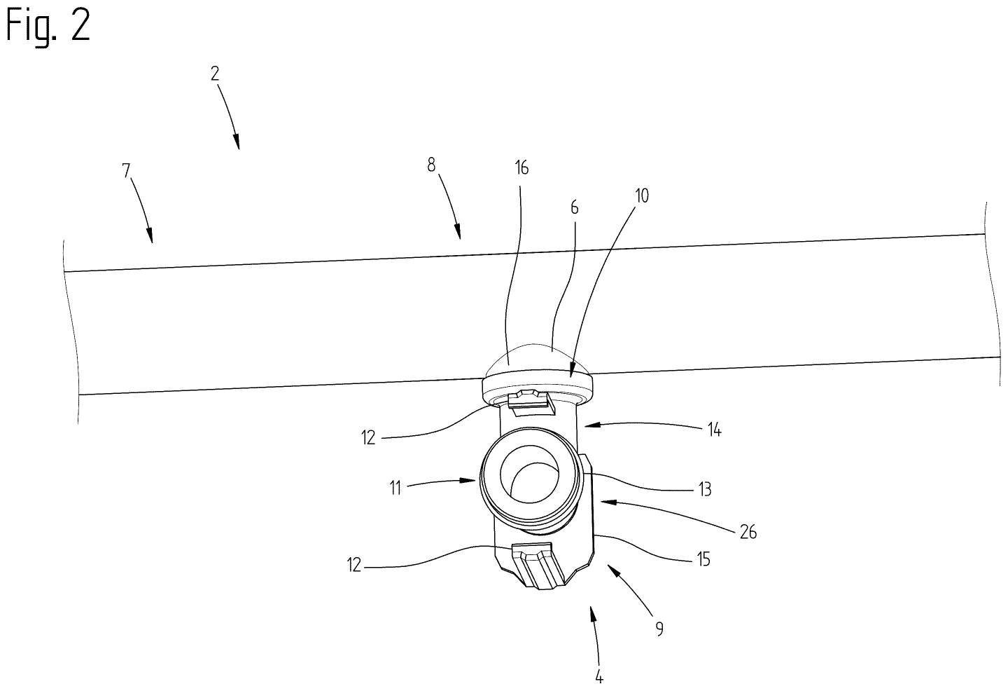

The connection of the secondary outlets 4 to the main tube 2 or the secondary openings 6 is shown enlarged in FIG. 2. The secondary opening 6 is preferably formed by a connection port 16, which is in particular ring-shaped and preferably circular. The connection port 16 preferably protrudes, for example by 3 mm, from an outer surface of the main tube 2, which may be oval, circular, or polygonal in cross-section.

In this embodiment, the secondary outlet 4 or some or all of the secondary outlets 4 advantageously comprise, as shown in FIG. 2, only one line connector 9. The line connector 9 preferably has a line connector body 26 and/or a seal 13. The seal 13 may be designed as a sealing ring and/or comprise an elastomer. The line connector body 26 advantageously has a connection section 10, a middle section 14, and/or a coupling section 11. The middle section 14 is conveniently arranged between the connection section 10 and the coupling section 11 and is advantageously hollow in order to connect the connection section 10 to the coupling section 11 in a fluid manner. The line connector body 26 or the coupling section 11 may be designed in particular as a male plug element. The seal 13 or sealing ring is preferably arranged on an outer side of the coupling section 11.

Advantageously, the line connector 9 or the line connector body 26 comprises at least one latching element 12 and preferably two latching elements 12 and, in particular, two latching arms. In this embodiment, the line connector 9 or the line connector body 26 comprises two latching arms arranged diametrically opposite each other, which extend with their longitudinal extension preferably parallel to the coupling section 11. The line connector 9 or the line connector body 26 may have a latching element base 15 to which the two latching elements 12 are preferably connected. In this embodiment, the connection section 10 of the line connector 9 or the line connector body 26 is connected to the connection port 16 of the main tube 2 in a material-locking manner, preferably by welding. The line connector body 26 is preferably made in one piece and, in particular, integrally.

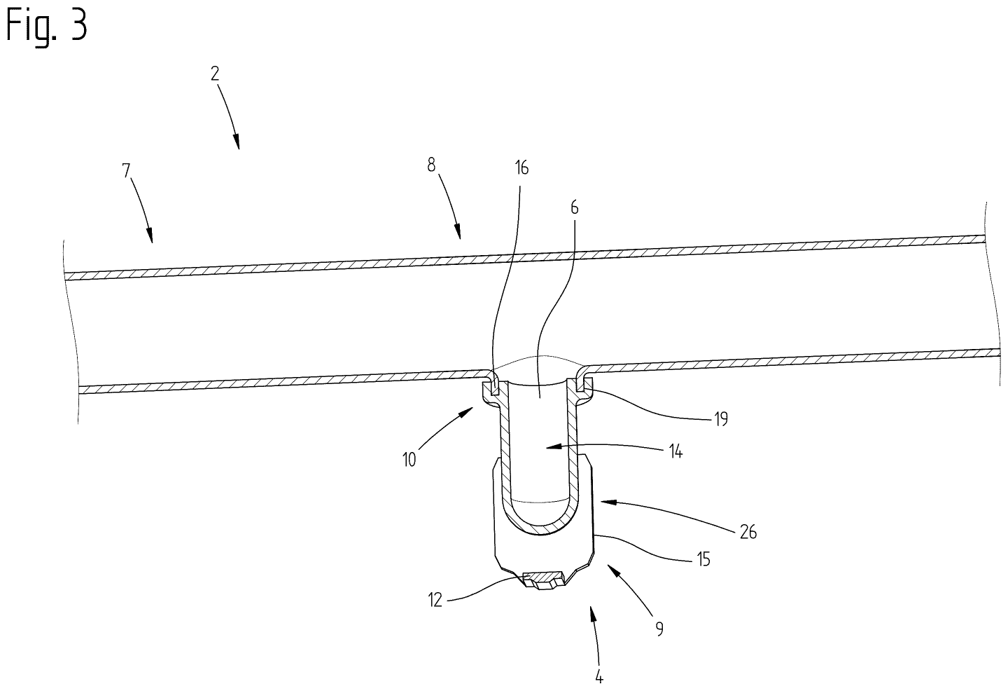

The longitudinal section through the main tube 2 and also through the line connector 9 or line connector body 26 shown in FIG. 3 illustrates how the secondary outlet 4 or the line connector 9 can be connected to the main tube 2. Advantageously, the connection section 10 of the line connector 9 comprises an outer wall and/or an inner wall. It is preferred that the connection section 10 has a recess 19—in particular a groove—for receiving a connection port 16. Preferably, the outer wall and/or the inner wall of the connection section 10 form the recess 19 or groove.

The connection port 16 of the main tube 2 in the form of the preferred annular collar may be inserted into or arranged in the recess 19 or groove of the line connector 9. It is possible that the connection port 16 inserted into the recess 19 enables the line connector 9 to be fastened to the main tube 2 by welding, for example by laser welding or rotation welding.

In this embodiment, the main tube 2 is produced by extrusion from a single-layer tube. Due to the extrusion, the cross-section of the tube/main tube is still constant along the longitudinal extension at this point. The continuously extruded tube or main tube 2 may then reach a forming tool, not shown here, for producing the intermediate sections 7 and the outlet sections 8, including the connection port 16 and the main opening 5 with the end pieces 17 not yet cut off.

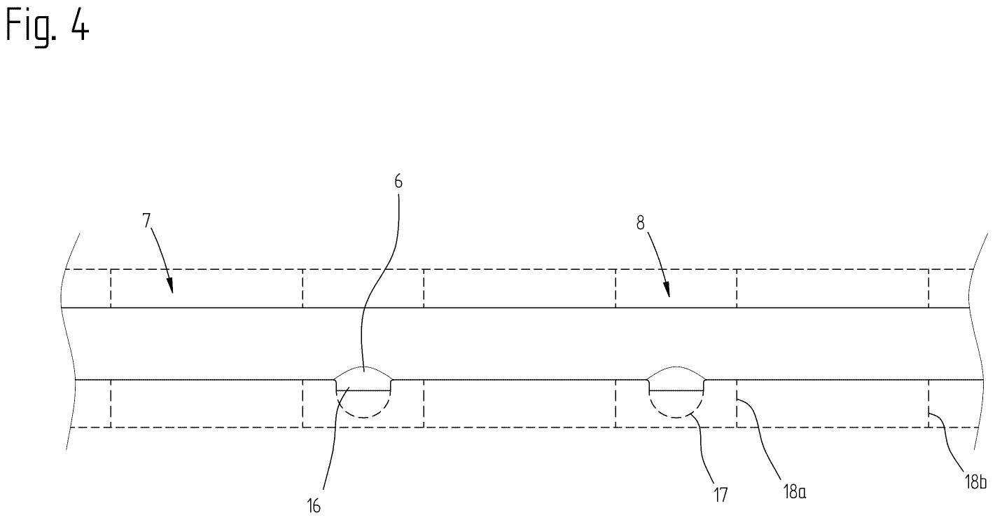

The forming tool may in particular have two circumferential chains, each of which has a plurality of chain links 18, 28 (symbolized by dashed lines in FIG. 4). The two chains conveniently move at the same speed, which corresponds to the travel speed of the tube or main tube 2. Preferably, each chain link 18, 28 of both chains abuts against an opposite chain link 18, 28 of the other chain when it reaches the main tube undergoing forming, so that the tube or main tube 2 is pressed between them and takes on the predetermined shape of the forming surfaces of the chain links 18, 28. For this purpose, the tube or main tube 2 may be subjected to slight pressure inside so that a corresponding dimensional accuracy is achieved.

Where a chain link 18, 28 strikes the opposite chain link 18, 28 of the other chain, a fine longitudinal burr 24 typically forms on the outside of the tube or main tube 2, extending in the axial direction. It is advantageous for the tube or main tube 2 to have at least one longitudinal burr 24 and preferably two longitudinal burrs 24 on its outer side. The two longitudinal burrs 24 are preferably arranged diametrically opposite each other with respect to the axis A.

As shown in FIG. 4, two axially adjacent chain links 18, 28 of a chain conveniently form a chain link transition 18a, 18b, wherein the chain link transitions 18a, 18b are symbolized as dashed lines. The main tube 2 conveniently comprises a plurality of cross burrs 23, which are formed in particular by two axially successive chain links 18, 28 of both chains and are located at the position of the chain link transitions 18a, 18b. It can be seen that the axial extension of the intermediate section 7 may be greater than that of the chain link 28. It is possible that the axial extension of an outlet section 8 is smaller than that of an associated chain link 18.

FIG. 4 shows the tube or main tube 2 of this embodiment without line connectors 9. The curved elements shown in dotted lines may be cut-off end pieces 17, through which the secondary openings 6 are formed. After the tube or main tube 2 has passed through the forming tool, it is conveniently passed past a cutting tool not shown here, which cuts off the end pieces 17 from the connection port 16. The continuously produced tube may then be repeatedly cut using a separating tool not shown here, so that the continuously produced tube is divided into main tubes 2 of defined lengths.

FIG. 5 shows a second embodiment of a main line 1 according to the present disclosure. The second embodiment is largely identical to the first embodiment, with the difference that, in contrast to the first embodiment, the main tube 2 has several corrugated tube segments 25. Preferably, each intermediate section 7 comprises at least one and preferably exactly one corrugated tube segment 25. In the second embodiment, the corrugated tube segments 25 are merely assigned to the intermediate sections 7 or are only components of the intermediate sections 7 and, in particular, are not components of the outlet sections 8. The intermediate sections 7 of this embodiment each have a corrugated tube-free section at their axial ends. The outlet sections 8 are preferably designed to be corrugated tube-free.

The corrugated tube segments 25 from FIG. 5 are preferably produced by means of corresponding chain links, which are not shown in FIG. 5 and are suitably designed differently from the chain links 28 from FIG. 4. The intermediate sections 7 can be axially longer than the corrugated tube segments 25 or the associated chain links. The outlet sections 8 are preferably formed by means of the chain links 18, wherein the chain links 18 may be axially longer than the outlet sections 8, see FIG. 4.

### LIST OF REFERENCE SIGNS

1 Main line
2 Main tube
3 Main outlet
4 Secondary outlet
5 Main opening
6 Secondary opening
7 Intermediate section of 2
8 Outlet section of 2
9 Line connector of 4
10 Connection section of 26
11 Coupling section of 26
12 Latching element of 9, 26
13 Seal of 9
14 Middle section of 26
Latching element base of 26
16 Connection port of 2
17 Cut-off end piece
18 Chain link for 8
18a,b Chain link transition
19 Recess of 9, 10, 26 for 16
20 Connecting body of 3
21 Tube section of 3
22 Tube connector of 3
23 Cross burr
24 Longitudinal burr
25 Corrugated tube segment
26 Line connector body of 9
27 Closed tube end
28 Chain link for 7, 25
A Axis

1. A main line for distributing or collecting a medium comprising:
a main tube and at least three outlets, wherein the outlets are connected to the main tube, wherein the outlets are each assigned to an opening of the main tube and are connected to the respectively associated opening, wherein the main tube comprises an axis A and defines an axial direction; and
wherein the main tube and/or at least one of the outlets comprises an elastomer.

2. The main line according to claim 1, wherein one of the outlets is a main outlet, wherein at least one of the outlets is a secondary outlet, wherein an inner diameter of the main outlet and/or the main tube is at least axially section wise larger than an inner diameter of the at least one secondary outlet.

3. The main line according to claim 1, wherein the main tube is formed in one piece.

4. The main line according to claim 1, wherein a weight proportion of the elastomer is at least 30% or 50% or 70%.

5. The main line according to claim 1, wherein at least one of the openings or secondary openings is formed by a connection port, wherein the connection port protrudes, at least in sections, radially outward relative to an outer surface of the main tube in a cross-section of the main tube.

6. The main line according to claim 1, wherein at least one of the outlets or secondary outlets has a connector or line connector, wherein the line connector comprises a connection section connected to the main tube or to an associated secondary opening or to an associated connection port of the main tube in a material-locking manner.

7. The main line according to claim 1, wherein the main tube comprises at least one corrugated tube section and preferably at least two corrugated tube sections.

8. A line system for distributing and collecting a temperature control medium, wherein the line system comprises a first main line according to claim 1, and wherein the tube system has a second main line according to claim 1.

9. A use of a main line according to claim 1 for temperature control of a drive battery of a vehicle.

10. A method for manufacturing a main line according to claim 1, comprising making the main tube from an extruded or coextruded tube.

11. The main line according to claim 1, wherein the medium is a temperature control medium.

12. The main line according to claim 1, wherein the main tube is formed as a monolithic piece.

13. The main line according to claim 1, wherein the main tube is integrally in layers.

14. The main line according to claim 1, wherein the main tube is formed completely integrally.

14. The main line according to claim 1, wherein the line connector comprises a connection section connected to the main tube or to an associated secondary opening or to an associated connection port of the main tube by welding.
